(19) United States
(12) Patent Application Publication
(10) Pub. No.: US 2005/0261018 A1
(43) Pub. Date: Nov. 24, 2005

(54) Communication methods and communication apparatuses

(75) Inventor: Hideaki Yamamoto, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Photo Imaging, Inc., Tokyo (JP)

(21) Appl. No.: 11/125,435

(22) Filed: May 10, 2005

(30) Foreign Application Priority Data
May 18, 2004 (JP) JP2004-147390

(51) Int. Cl. H04Q 7/20

(52) U.S. Cl. 455/522

(57) ABSTRACT

A communication method comprises a transmitting a first signal while decreasing its output from a first communication apparatus to a second communication apparatus, receiving the response signal from the second communication apparatus, detecting the lower limit of the transmitted power output that can be received by the second communication apparatus based on the transmitted power output of the first signal transmitted and the response signal received, and a second signal transmission step of transmitting a second signal from the first communication apparatus to the second communication apparatus with the transmitted power output based on the power output detected in the minimum output detection step.

This application claims priority from Japanese Patent Application No. 2004-147390 filed May 18, 2004, which is incorporated hereinto by reference.

### FIELD

The present invention relates to communication methods and communication apparatuses, and more specifically to communication methods and communication apparatuses that carry out wireless communication.

### BACKGROUND

The demand for wireless LAN systems is increasing because of the increase in their speed and because of the decrease in their prices. In addition to the Bluetooth and IEEE (Institute of Electrical and Electronics Engineers) 802.11 wireless communication network standards, in recent years, there is a very strong activity of standardization of short range wireless personal area networks with speeds in excess of 20 Mbps as typified by the IEEE 802.15.3 standard.

For example, in the UWB (Ultra Wide Band) transmission method, data signal is composed as a series of impulse signals with extremely short periods of about 100 picoseconds, and the communication is carried out by transmitting and receiving such series of impulse signals. The bandwidth occupied by these signals is extremely wide being on the order of several GHz, and such signals can easily coexist with communication systems based on other methods (see, for example, Japanese Unexamined Patent Application Laid Open No. 2003-143644).

As an example of a communication system using a short range wireless personal area network is present a network printing system in which a mobile telephone with camera is provided with a communication section that carries out communication via a wireless LAN, when the user, who has acquired an image data by photographing and is carrying the mobile telephone with camera, enters within the communicable area of the wireless LAN communication apparatus, the image data is transmitted to the wireless LAN communication apparatus and is stored in the image server located in the photo shop (see, for example, Japanese Unexamined Patent Application Laid Open No. 2003-281028).

However, in a short range wireless communication system such as an UWB or Bluetooth system, all the equipment present within the communication range (for example, from 10 meters to 100 meters) will be the target of the inquiry message for detecting the equipment present in the surrounding area (hereinafter referred to as the equipment search signal). Therefore, a very large number of response messages will have to be received when a large number of equipment are present in the surrounding area that are capable of communication.

Normally, it is necessary to have an operating procedure in which the information of the equipment included in these response messages is presented by displaying on a display device, etc., and the user is made to select the desired equipment. If there is a large number of equipment present in the surrounding area, the user has to spend and extremely long time for that selection operation, and hence there was the problem that the ease of operation gets deteriorated, and there was the possibility that an excessive load is placed on the user.

Regarding the above problem, in the case of carrying out wireless communication using a plurality of communication apparatuses, a proposal has been made so that, when the specific connection operations are made with the first communication apparatus after restricting to a short range the distance up to which the transmission can be made and the equipment search signal for detecting equipment that can become a target for connection in wireless communication is transmitted as radio waves, and when certain specific awaiting operations are made in the second communication apparatus, the processing is made of establishing connection between the first communication apparatus and the second communication apparatus (see, for example, Japanese Unexamined Patent Application Laid Open No. 2004-15558).

Further, even in the above wireless communication, considerations have been given to the security of the communicated data. For example, in the IEEE 802.11 standard, the authorization information ESS-ID is used for establishing connection with a fixed counterpart. WEP (Wired Equivalent Privacy) is set in a wireless LAN system. WEP is a function that strengthens the security by setting up an encoding key for the wireless packet. In a system using WEP the communication is established only when the WEP set for the first wireless communication apparatus matches with the WEP set for the second wireless communication apparatus.

While the operations of selecting the desired equipment and the operations of strengthening the security will be necessary when carrying out wireless communication, once the initial setting has been made further setting operations are not necessary.

On the other hand, in portable type of communication apparatus, when the wireless communication environment changes because of the movement of the user carrying the communication apparatus, although it is necessary to carrying out operations for changing the settings, it will force users not familiar with the operations to carry out-work that they cannot comprehend, and as a result it is possible that wireless communication may not be possible because of incorrect settings, thereby leading to the danger of the authentication information being leaked.

In the disclosure made in Japanese Unexamined Patent Application Laid Open No. 2004-15558, although the danger of incorrect settings and of the authentication information being leaked was reduced by carrying out wireless communication by restricting to a short range the distance to which the inquiry message can be transmitted, there were times when satisfactory wireless communication could not be achieved. In other words, while the distance to which the transmission can be made was being restricted to a circular range with a diameter of 15 centimeters, the electromagnetic waves were absorbed or reflected depending on the orientation of the terminal equipment, the weather, and the installation environment, etc., and hence there were cases when the electromagnetic waves could not reach the desired equipment or reached equipment other than the intended ones.

In particular, when the image data photographed by a photographing apparatus such as a mobile telephone with camera is printed in a printer via wireless communication or is transferred to a print order reception terminal placed within a shop or any public facility, it is very rare that the range of propagation of the electromagnetic waves is a true circle (true sphere) due to the effects of the motor or the power supply circuit within the photographing apparatus, and when the range of propagation is taken as a maximum of 15 centimeters, there were even some directions in which the waves reached only about a mere few centimeters. On the other hand, when the range of propagation was a minimum of 15 centimeters, the maximum communication area was enlarged to a region of more than 1 meter thereby increasing the fear of information leakage or of wrong settings.

Further, it is quite possible that several units of print order reception terminals are placed within a single shop, and it is likely that the electromagnetic waves from the apparatus of one user reach a terminal other than the print order reception terminal being operated by that user. Even when the secrecy of the image data photographed by the photographing apparatus is not high, there is a tendency among people to shun their photographs being seen by a number of unknown strangers, and there is an extremely high demand for avoiding image data transfer that is not intended by the users.

### SUMMARY

In view of this, the invention provides a communication method of a communication apparatus that permit wireless communication of authentication information or setting information in a stable manner without being affected the orientation of the communication apparatus, weather, installation environment, etc.

The purpose of the invention can be achieved by having the following configurations.

One preferred embodiment is a communication method of carrying out wireless communication between a first communication apparatus and a second communication apparatus, with the feature that it comprises a first signal transmission step of transmitting a first signal while decreasing its output from a first communication apparatus targeting a second communication apparatus, a response signal receiving step of receiving the response signal from the second communication apparatus in answer to the first signal transmitted-during said first signal transmission step, a minimum output detection step that detects the lower limit of the transmitted power output that can be received by the second communication apparatus based on the transmitted power output of the first signal transmitted during said first signal transmission step and the response signal received in said second response signal receiving step, and a second signal transmission step of transmitting a second signal from the first communication apparatus targeting the second communication apparatus with the transmitted power output being equal to that detected in said minimum output detection step.

Further, this is a communication method with the feature that said second signal is a signal that includes information related to the communication settings of the second communication apparatus, and with the feature that this method includes a communication setting step of carrying out the communication setting of the second communication apparatus based on the second signal transmitted during said second signal transmission step, and a high output communication step during which the first communication apparatus and the second communication apparatus carry out high output wireless communication using the communication settings set during said communication setting step.

Further, this is a communication method with the feature that said second signal is a signal that includes an encoding key for encoding data, and with the feature that this method includes a data encoding step of encoding the data based on the second signal transmitted during said second signal transmission step, and a high output communication step during which the first communication apparatus and the second communication apparatus carry out high output transmission of data encoded in set data encoding step.

Another preferred embodiment is a communication method of carrying out wireless communication between a first communication apparatus and a second communication apparatus, with the feature that it comprises a first signal transmission step of transmitting an equipment search signal for detecting an equipment that becomes the target of connection of wireless communication while decreasing the output of said equipment search signal from a first communication apparatus targeting a second communication apparatus, a response signal receiving step of receiving the response signal from the second communication apparatus in answer to the equipment search signal transmitted during said first signal transmission step, a minimum output detection step that detects the lower limit of transmitted power output that can be received by the second communication apparatus based on the transmitted power output of the equipment search signal transmitted during said first signal transmission step and the response signal received in said second response signal receiving step, a data encoding key issuing step of issuing the encoding key for encoding the data, and a second signal transmission step of transmitting the encoding key issued during said encoding key issuing step from the first communication apparatus targeting the second communication apparatus with the transmitted power output being equal to that detected in said minimum output detection step, a data encoding step of encoding data based on the encoding key transmitted during said second signal transmission step, a third signal transmission step of transmitting the data encoded during said data encoding step from the first communication apparatus targeting the second communication apparatus, and a data decoding step of decoding the data transmitted during said third signal transmission step based on the encoding key issued during said data encoding key issuing step.

Yet another preferred embodiment is a communication apparatus that has a wireless communication section and that carries out wireless communication with other communication apparatuses, with said communication apparatus having the feature that it comprises a wireless output control section that controls the transmitted power output of said wireless communication section and a minimum output detection section that detects the lower limit of transmitted power output that can be received by other communication apparatuses, and said wireless output control section makes said wireless communication section transmit the first signal to the other communication apparatus while reducing the transmitted power output, and also makes it transmit the second signal to the other communication apparatus at a transmitted power output equal to the transmitted power output detected by said minimum output detection section, said wireless communication section receives the response signal from the other communication apparatus sent in answer to the first signal transmitted previously, and said minimum output detection section detects the minimum transmitted power output that can be received by the other communication apparatus based on the transmitted power output of the first signal transmitted by said wireless communication apparatus, and the response signal received by said wireless communication apparatus from the other communication apparatus sent in answer to the first signal.

Further, said second signal is a signal that includes information related to the communication settings of the other communication apparatus, and said wireless communication section carries out high output wireless communication with the other communication apparatus using the communication settings included in said second signal.

Further, said communication apparatus has the feature that said second signal is a signal including an encoding key for encoding the data, and said wireless communication section receives the data that has been encoded using the encoding key included in said second signal.

Yet another preferred embodiment is a communication apparatus that has a wireless communication section and that carries out wireless communication with other communication apparatuses, with said communication apparatus having the feature that it comprises a wireless output control section that controls the transmitted power output of said wireless communication section, a minimum output detection section that detects the lower limit of the transmitted power output that can be received by other communication apparatuses, a data encoding key issuing section that issues the encoding key for encoding the data, and a data decoding section that decodes the data based on the encoding key issued by said data encoding key issuing section, wherein said wireless output control section makes said wireless communication section transmit the equipment search signal for detecting an equipment that becomes the target of connection of wireless communication targeting other communication apparatuses while reducing the transmitted power output and also makes it transmit the encoding key issued by said data encoding key issuing section targeting the other communication apparatus at a transmitted power output equal to the transmitted power output detected by said minimum output detection section, said wireless communication section receives the response signal from the other communication apparatus sent in answer to the equipment search signal transmitted previously, said minimum output detection section detects the minimum transmitted power output that can be received by the other communication apparatus based on the transmitted power output of the equipment search signal transmitted by said wireless communication apparatus and based on the response signal received by said wireless communication apparatus from the other communication apparatus sent in answer to the equipment search signal, said wireless communication section then receives the encoded data, and said decoding section decodes the data received using said wireless communication section.

### BRIEF DESCRIPTION OF THE DRAWINGS

FIG. 1: This is a block diagram showing conceptually the functional configurations of the first communication apparatus and the second communication.

FIG. 2: This is a perspective view showing schematically the external appearance of a reception terminal.

FIG. 3: This is a block diagram showing the internal configuration of the control section of the reception terminal of FIG. 1.

FIG. 4: This is a block diagram showing the internal configuration of the wireless communication section of the reception terminal of FIG. 1.

FIG. 5: This is a block diagram showing the internal configuration of the control section of the mobile telephone unit with camera of FIG. 1.

FIG. 6: This is a flow chart showing the wireless communication operations carried out by the first communication apparatus and the second communication apparatus.

FIG. 7: This is a flow chart showing the communication establishment operations in Step S10 of FIG. 6.

FIG. 8: This is a schematic diagram showing an example of a display screen displayed in the display device of a reception terminal.

FIG. 9: This is a flow chart showing the image data transfer processing in Step S20 of FIG. 6.

FIG. 10: This is a flow chart showing the print order reception processing in the reception terminal 10 during Step S30 in FIG. 6.

### DESCRIPTION OF THE PREFERRED EMBODIMENT

The preferred embodiments are described here while referring to the drawings.

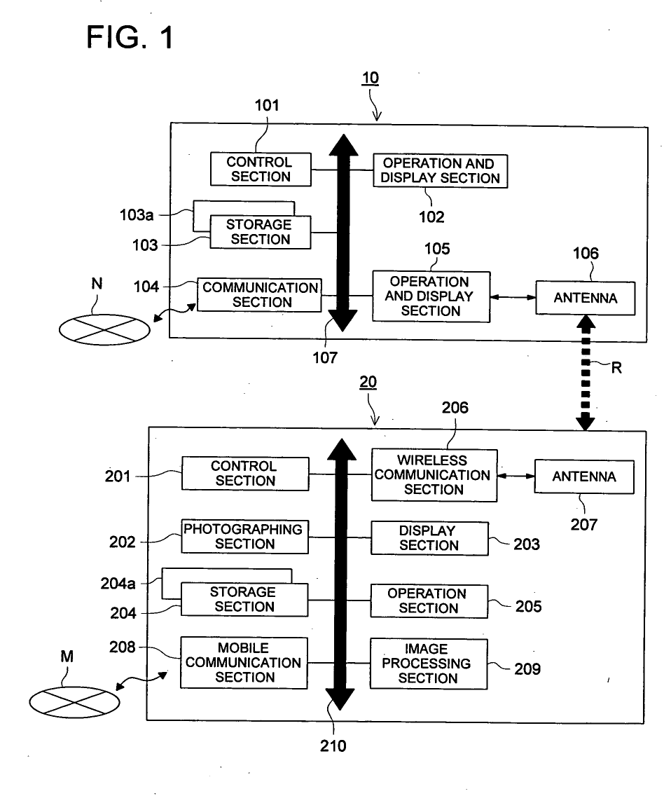

FIG. 1 is a block diagram showing conceptually the functional configurations of the first communication apparatus and the second communication.

The wireless communication system comprises the reception terminal 10 which is the first communication apparatus and the mobile telephone unit 20 with camera which is the second communication apparatus, and the reception terminal 10 and the mobile telephone unit 20 with camera can carry out wireless communication between them via the wireless signals R.

The reception terminal 10 comprises the control section 101, the operation and display section 102, the storage section 103, the communication section.104, and the wireless communication section 105, etc., all of which are interconnected by the bus 107. The reception terminal 10 has the functions of not merely reading via a communication medium or a storage medium and displaying the image data photographed using a photographing apparatus such as a digital still camera or a mobile telephone unit with camera, but also of receiving the print order or mailing addresses for that image data, and transferring the image data and print orders via a network N to an image server not shown in the figure or to the mailing address, etc.

The control section 101 of the reception terminal 10 is configured using a CPU (Central Processing Unit) and a working storage, etc., reads the programs stored in the storage section 103 into the working storage, and carries out central control of the different sections of the reception terminal 10 following those programs.

The operation and display section 102 of the reception terminal 10 is configured using a pressure sensitive type (pressure sensitive resistive film type) of touch panel in which transparent electrode are arranged in the form of a grid and a variety of operation buttons, and has the functions of displaying the read in image data, displaying various types of guidance displays and status displays to the user, and receiving various types of operations made by the user, and detects the X-Y coordinates of pressure points which are pressed by finger or by a touch pen and button operations, and outputs them as operation signals to the control section 101.

The storage section 103 of the reception terminal 10 is configured using a non-volatile semiconductor memory such as EEPROMs (Electrically Erasable Programmable Read-Only Memory) and volatile memory such as SDRAMs (Synchronous Dynamic Random Access Memory), and various types of programs that can be executed in the reception terminal 10 and contents of settings depending on the functions, etc., are stored in the non-volatile memory, and the image files, etc., received by the communication section 104 are the wireless communication section 105 are stored in the volatile memory.

The removable memory 103a is a storage medium that can be inserted into and removed from the reception terminal 10 or the mobile telephone unit 20 with camera, which use card-shaped or stick-shaped semiconductor memories, for example, flash memories, are used and which are used for storing various types of data including image files. The image data stored in the removable memory 103a is stored in a publicly known image file format and is read out when the removable memory 103a is inserted into the reception terminal 10. Further, when reading out the image data by inserting the removable memory 103a into the reception terminal 10, since no wireless communication is used in this case, the image data will be read out without having to pass through the procedures of authentication or encoding and hence the image data can be read out at a high speed.

The communication section 104 of the reception terminal 10 is connected to the network N which is a communication medium such as a LAN, etc., and has the functions of transmitting and receiving various types of data including image files and print orders to and from image servers or printing apparatuses not shown in the figure but connected to the network N using one or more types of network protocols.

The wireless communication section 105 of the reception terminal 10, similar to the communication section 104, has the functions of transmitting and receiving using one or more types of network protocols, via wireless signals R, various types of data including image files and various types of control data to and from mobile telephone units 20 with cameras, digital still cameras, PDAs (Personal Digital Assistants), etc., that have wireless communication functions.

In addition, they remove particular restriction on the method of wireless communication or on the communication protocol, and the methods of W-CDMA, cdma2000, SS (Spread Spectrum), OFDM (Orthogonal Frequency Division Multiplexing), UWB transmission method which is also called the Wireless USB Method, Bluetooth, Wi-Fi (Wireless Fidelity), etc., are used. Among these the UWB transmission method and Bluetooth short range communication are used desirably, and further it is desirable to use the UWB transmission method which has the high transmission speed at short ranges. Also, the wireless communication section 105 is equipped with an antenna 106.

The mobile telephone unit 20 with camera has the function of recording image data obtained by photographing the subject in the image file format. The mobile telephone unit 20 with camera comprises the control section 201, the photographing section 202, the display section 203, the storage section 204, the operation section 205, the wireless communication section 206, the mobile communication section 208, and the image processing section 209, etc., all of which are interconnected by the bus 210.

The control section 201 has the mobile telephone unit 20 with camera, has a configuration similar to the control section 201 of the reception terminal 10, and carries out central control of the different sections of the mobile telephone unit 20 with camera.

The photographing section 202 is composed of a photographing lens, electronic flash, and an optoelectronic conversion device such as CCD (Charged Coupled Device), etc., not shown in the figure, and carries out A/D conversion of the electric charge signal obtained by photo-electronic conversion of the optical image of the subject at each pixel of the CCD, and outputs an image with a 10-bit digital signal.

The display section 203 comprises an LCD (Liquid Crystal Display), etc., and displays on the screen based on the display signal input from the control section 201 the image data output by the photographing section 202, or the various settings or the statuses of the mobile telephone unit 20 with camera.

The storage section 204 of the mobile telephone unit 20 with camera stores, similar to the storage section 103 of the reception terminal 10, various programs that can be executed in the mobile telephone unit 20 with camera or the contents of settings corresponding to the functions, etc.

The removable memory 204a is a memory that can be inserted into or removed from the mobile telephone unit 20 with camera or the reception terminal 10, similar to the removable memory 103a, and stores the image data output by the photographing section 202 in a publicly known image file format.

The operation section 205 is provided with various types of operation buttons, and detects the button operations for various types of operations of mobile telephone functions, the zoom operations of the photographing section, and for the display and setting of various types of menu settings, and outputs the corresponding operation signals to the control section 210. Similar to the display and operation section 102 of the reception terminal 10, the operation section 205 is configured using a pressure sensitive type (pressure sensitive resistive film type) of touch panel in which transparent electrode are arranged in the form of a grid and can share the functions with the display section 204. In this case, it detects the X-Y coordinates of pressure points which are pressed by finger or by a touch pen and button operations, and outputs them as operation signals to the control section 201.

Similar to the wireless communication section 105 of the reception terminal 10, the wireless communication section 206 of the mobile telephone unit 20 with camera is provided with an antenna 207, and has the functions of transmitting and receiving using one or more types of network protocols, via wireless signals R, various types of data including image files and various types of control data to and from reception terminals 10, mobile telephone units 20 with cameras, PDAs, etc., that have wireless communication functions.

The mobile communication section 208 realizes the functions of a mobile telephone, and is configured to comprise ASICs (Application Specific Integrated Circuits), memory, etc., not shown in the figure, and not only carries out transmission and reception of voice or image data converted into signals with other mobile telephone or information processing apparatuses via the mobile communication network M, but also carries out the conversion to signals of the sounds in telephone conversation and the decoding of the voice converted into signals.

The image processing section 209 is configured to comprise ASICs not shown in the figure, and carries out well known image processing operations such as dark level compensation, gamma (γ) correction, white balance correction, etc., on the image data output from the photographing section 202.

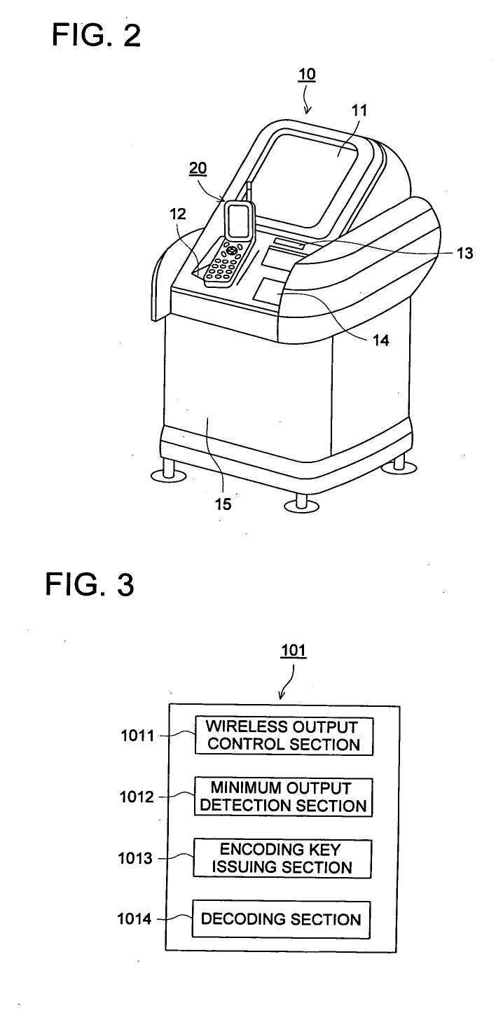

FIG. 2 is a perspective view showing schematically the external appearance of a reception terminal which is the first communication apparatus.

The reception terminal 10 is provided with a touch panel 11, a cradle 12, a memory card slot 13, and operation buttons 14, all of which are contained in the body 15.

The touch panel 11 and the keyboard 14 form a part of the operation and display section 102 of FIG. 1. The touch panel 11 displays the image data that has been read out, gives various types of guidance displays or status displays to the user, and accepts various types of operation inputs from the user. The keyboard 14 accepts various types of operation inputs from the user.

The cradle 12 is a stand on which it is possible to place communication apparatuses such as a mobile telephone unit 20 with camera or a digital still camera, etc., and its surface is made non-slippery in order to prevent the slipping of communication apparatus placed on it. Further, an antenna 107 of FIG. 1 is built into the wall surface constituting the cradle 12 and makes wireless communication possible with the mobile telephone unit 20 with camera that has come within a very short distance of it. Further, in order to carry out more definite wireless communication, it is desirable that a lid body is provided in the cradle 12 and an antenna 107 is also built into the lid body.

The memory slot 13 functions as an interface with the removable memory 103a of FIG. 1, and it is possible to insert in it a removable memory such as a Multimedia Card®, Memory Stick®, etc.

The details of the control section 101 of the reception terminal 10 shown in FIG. 1 are described here using FIG. 3. FIG. 3 is a block diagram showing the internal configuration of the control section 101 of the reception terminal 10 of FIG. 1.

The control section 101 has the functions of the wireless output control section 1011, the minimum output detection section 1012, the encoding key issuing section 1013, and the decoding section 1014.

The wireless output control section 1011 controls the transmitted power output of the signal transmitted from the wireless communication section 105.

The wireless output control section 1011 carries out not only the automatic control of the transmitted power output (ATP: Automatic Transmitter Power Control) that is carried out in a large number of wireless communication apparatuses including mobile communication apparatuses, but also carries out the control of the reduced output power mode by detecting the lower limit of the transmitted power at which reception is possible by the mobile telephone unit 20 with camera which is the second communication apparatus, and the low output power mode of setting the transmitted power output to the power at which reception is possible by the mobile telephone unit 20 with camera which is the second communication apparatus.

During the ATP for the first communication apparatus, the second communication apparatus measures the strength of the signal transmitted on the first communication apparatus at a predetermined timing (for example, at every 0.625 ms), transmits a command to the first communication apparatus to reduce the transmitted power output if the strength of the signal is larger than the target value, or else transmits a command to the first communication apparatus to increase the transmitted power output if the strength of the signal is smaller than the target value. On the other hand, the first communication apparatus controls the transmitted power output by varying the transmitted power output based on the transmission output control command transmitted by the second communication apparatus. Further, “high output wireless communication” in the invention implies the wireless communication in the state in which said ATP is being carried out.

During the reduced power output mode control, irrespective of the transmission output control command transmitted by the second communication apparatus, the signal transmission is continued while reducing the transmitted power output at a predetermined timing, and not only the transmission output control command sent as the response signal from the second communication apparatus is received but also the strength of the received signal is measured. Further, at this time, the transmission output power control command is sent from the first communication apparatus to the second communication apparatus instructing the second communication apparatus to maintain the transmitted power output so that the transmitted power output of the second communication apparatus becomes constant. The transmitted power output, for example, is reduced by about 60 to 70 dB when reducing the transmitted power output is to be reduced so as to make the range of wireless communication to have a radius of about 15 cm compared to the radius of about 10 meters during normal communication.

During the low output mode control, irrespective of the transmission output control command transmitted by the second communication apparatus, the signal transmission is continued targeting the second communication apparatus at a transmitted power output equal to that directed by the minimum output power detection section 1012 to be described later. Further, at this time, the transmission output power control command is sent from the first communication apparatus to the second communication apparatus instructing the second communication apparatus to maintain the transmitted power output so that the transmitted power output of the second communication apparatus becomes constant.

The minimum output power detection section 1012 detects the lower limit of the transmitted power output at which the second communication apparatus can carry out signal reception.

The phrase “the lower limit of the transmitted power output at which the second communication apparatus can carry out signal reception” in the invention implies a transmitted power output at which only the second communication apparatus can receive the signals, and preferably is the lowest transmitted power output at which only the second communication apparatus can receive the signals.

With the wireless communication section 105 being in the reduced power output mode, if there is only one transmission output power control command sent from only one mobile telephone unit 20 with camera which is the second communication apparatus, the minimum output power detection section 1012 makes the transmitted power output of the signal transmitted from the wireless communication section 105 equal to the lower limit of the transmitted power output at which the second communication apparatus can carry out signal reception.

Still more desirably, with the wireless communication section 105 being in the reduced power output mode, the transmitted power output of the signal transmitted from the wireless communication section 105 is made equal to the lower limit of the transmitted power output at which the second communication apparatus can carry out signal reception just before it becomes impossible to receive the transmission output power control command transmitted from the second communication apparatus, that is, just before it becomes impossible for the second communication apparatus to receive the signal transmitted from the first communication apparatus.

The encoding key issuing section 1013 issues the encoding key that is necessary for encoding the data transmitted and received during high power output wireless communication carried out by the reception terminal 10 which is the first communication apparatus and the mobile telephone unit 20 with camera which is the second communication apparatus. The encoding key is, for example, is a literal string with a data length of 128 bits, or more concretely, a code key used in the encoded data communication methods typified by WEP or EAP-MD5 (Extensible Authentication Protocol—Message Digest 5), in which the data is divided into several optional blocks and the code key comprises the parameters defining the data length of division into blocks and the order of transmission of blocks, and it is possible to issue the key by selecting from the keys stored beforehand in the storage section 103 of FIG. 1 or by generating the key by computation each time the encoding key is issued. Preferably, the encoding key is issued at regular intervals of time and the encoding key used for wireless communication between the first communication apparatus and the second communication apparatus is changed every time a new key is issued.

The decoding section 1014 decodes the data encoded based on the encoding key using the encoding key issued by the encoding key issuing section 1013, that is, the decoding section 1014 returns the data to the original state before encoding. During decoding, the reverse transformation of data is made using the encoding key issued by the encoding key issuing section 1013 or the reverse transformation of data is made using a decoding key that has been issued beforehand corresponding to said encoding key.

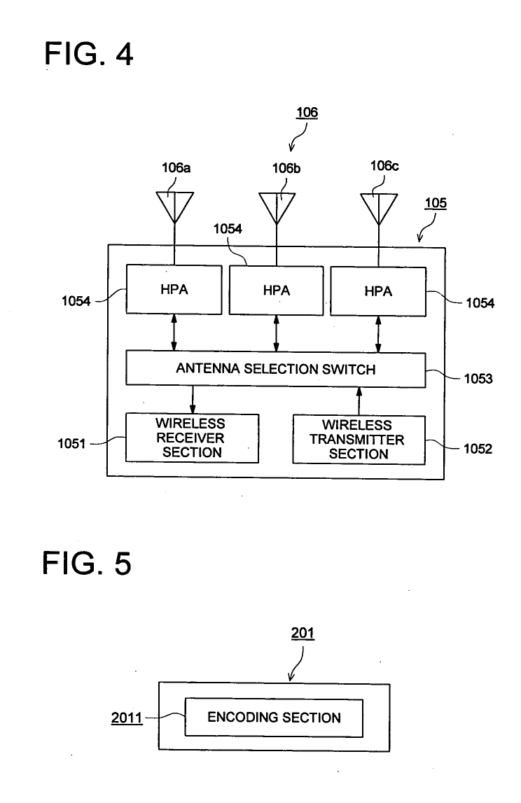

The details of the wireless communication section 105 of the reception terminal 10 shown in FIG. 1 are described here using FIG. 4. FIG. 4 is a block diagram showing the internal configuration of the wireless communication section 105 of the reception terminal 10 of FIG. 1.

The wireless communication section 105 comprises the wireless receiver section 1051, the wireless transmitter section 1052, the antenna selection switch 1053, the high power amplifier (HPA) 1054, and the directional antennas 106a, 106b, 106c, etc.

The directional antennas 106a, 106b, 106c, etc., are antennas used for both transmission and reception, and are provided in the different wall surfaces constituting the cradle 12 in FIG. 2, the directionality of each antenna is different from the directionalities of the other antennas. Further, considering the situation when no mobile telephone unit 20 with camera is placed on the cradle, it is desirable that an omni-directional antenna not shown in the figure is incorporated into the body 15 so that it is possible to carry out stable wireless communication without being affected by the orientation of the communication apparatus, the items possessed by the user, the weather, or the installation environment, etc.

The wireless receiver section 1051 down-converts the received signal to the baseband signal, carries out its demodulation and A/D conversion and outputs the result of processing the control section 101. The wireless transmitter section 1052 modulates the data that is to be transmitted and that is output from the control section 101, and transmits it after up-conversion to the data signal for wireless communication.

The antenna selection switch 1053 has a function of selecting the directional antennas 106a, 106b, 106c, etc. The selection of the directional antennas is made based on the strength of the signal transmitted from the mobile telephone unit 20 with camera and receive from each of the directional antennas 106a, 106b, 106c, etc., or by the omni-directional antenna not shown in the figure, and based on the transmission output control command transmitted by the mobile telephone unit 20 with camera, so that optimum wireless communication is carried out.

The high power amplifier (HPA) 1054 carries out amplification of the signal received from or transmitted to the directional antennas 106a, 106b, 106c, etc. Automatic gain control (AGC: Automatic Gain Control) is carried out for the received signal, so that the received signal is amplified up to the specific signal strength and output to the wireless receiver section 1051. For the transmitted signals, the strength of the signal to be amplified is changed depending on the control mode of the wireless output control section 1011 of FIG. 3.

The details of the control section 201 of the mobile telephone unit 20 with camera shown in FIG. 1 are described using FIG. 5. FIG. 5 is a block diagram showing the internal configuration of the control section 201 of the mobile telephone unit 20 with camera shown in FIG. 1.

The control section 201 has the function of the encoding section 2011.

The encoding section 2011 receives the encoding key stored previously in the storage section 204, or the encoding key issued by the encoding key issuing section 1013 of the reception terminal 10 and transmitted from the wireless communication section 105, and encodes the data to be transmitted to the reception terminal 10 using the received encoding key.

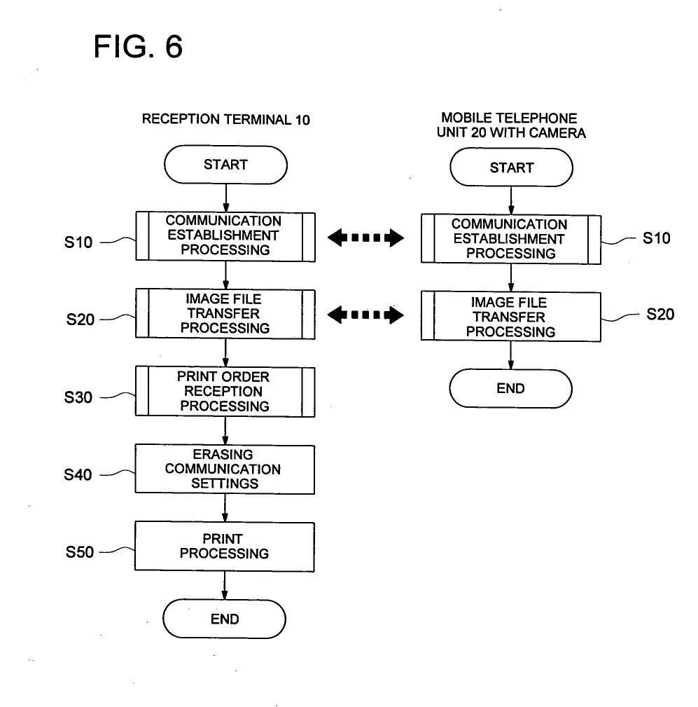

Next, an example of the operation of a wireless communication system is described here referring to FIG. 6 to FIG. 10.

FIG. 6 is a flow chart showing the wireless communication operations carried out by the reception terminal 10 which is the first communication apparatus and the mobile telephone unit 20 with camera which is the second communication apparatus.

Further, the flow chart of FIG. 6 is for the condition in which the power supply is ON in the reception terminal 10 and in the mobile telephone unit 20 with camera, and in the condition in which image data has been acquired by photographing in the mobile telephone unit 20 with camera, and after the user has made the operation instructing the reception terminal 10 to start processing.

The processing for establishing the communication between the reception terminal 10 and the mobile telephone unit 20 with camera is carried out in Step S10. In concrete terms, wireless communication with security is started between reception terminal 10 and the mobile telephone unit 20 with camera possessed by the user operating the reception terminal 10.

Image data is transferred in Step S20 from the mobile telephone unit 20 with camera to the reception terminal 10.

Print order reception processing is done in Step S30 in the reception terminal 10.

In Step S40, in the reception terminal 10, all the communication settings made during Step S10 are erased from the storage section 103. By doing so, it is possible to reduce the possibility of leakage of information such as image data or personal information.

In Step S50, the print order execution processing is carried out in the reception terminal 10.

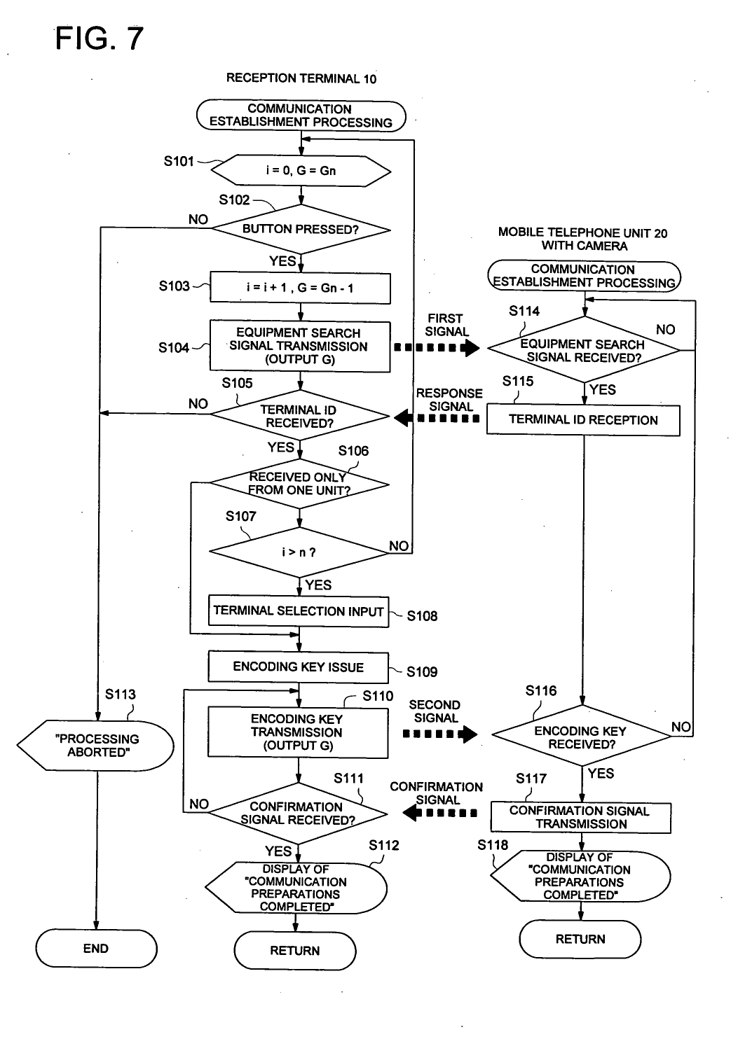

The processing for establishing the communication in Step S10 of FIG. 6 is explained here using FIG. 7. FIG. 7 is a flow chart showing the communication establishment operations in Step S10 of FIG. 6, in which Steps S101 to S113 indicate the processing done in the reception terminal 10 and the Steps S114 to S118 indicate the processing done in the mobile telephone unit 20 with camera.

In Step S101, parameter initialization is done for carrying out to reduce output power mode control in the wireless output control section 1011 of FIG. 3. In specific terms, the counter ‘i’ is made ‘0’, and the value of the transmitted signal output power G is made equal to a previously said value Gn. Here, it is desirable that Gn is a value corresponding to a maximum signal transmission range of 3 meters.

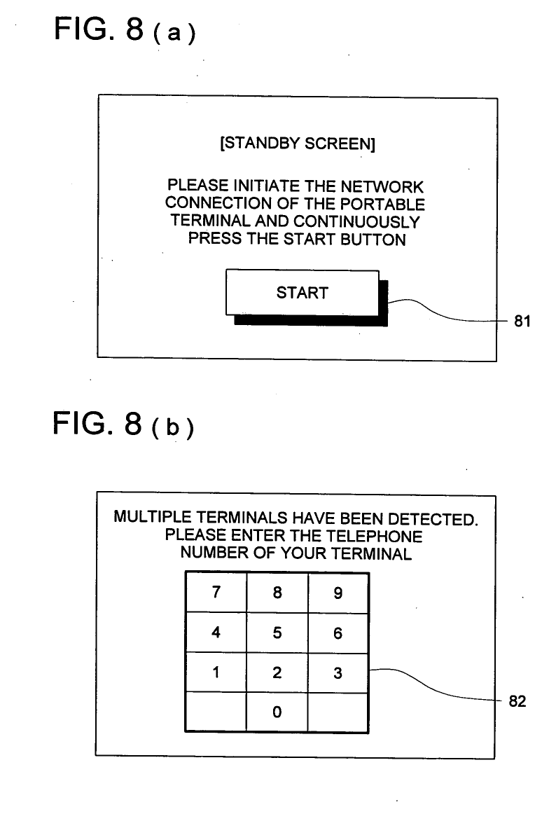

In Step S102, the judgment is made as to whether or not a button constituting the operation and display section 102 of FIG. 1 has been pressed. In concrete terms, when the screen shown in FIG. 8(a) has been displayed in the touch panel 11, the judgment is made as to whether or not the user has pressed the Start button 81 displayed in the screen, that is, the judgment is made as to whether or not the corresponding operation signal has been output from the operation and display section 102.

Returning to FIG. 7, if it is judged that the button has been pressed (Step S102: YES), the processing of Step S103 is executed assuming that the user is desiring the operations to be continued, and if it is judged that the button has not been pressed (Step S102: NO), it is assumed that the operations have been stopped in the middle and a screen with the message “Processing aborted” is displayed on the touch panel (Step S113), and the processing is terminated.

The counter ‘i’ is incremented by 1 in Step S103, and the transmitted signal output power G is reduced by one step.

In Step S104, the equipment search signal which is the first signal is transmitted from the wireless communication section 105 with a transmitted signal output power of G (the first signal transmission process).

Here, the signals exchanged between the reception terminal 10 and the mobile telephone unit 20 with camera are composed with a header section and a data section, and the header section with a data length of 54 bits includes the communication ID unique to the communication apparatus, the control command targeted to the destination communication apparatus, and the data length of the data section, and the data section includes the data of the data length described in the header section.

Further, the equipment search signal is a signal transmitted to search for equipment that can carry out wireless communication with the reception terminal 10, and the content of the signal is set appropriately depending on the wireless communication method. For example, in the Bluetooth method the inquiry message including the IAC (Inquiry Access Code) corresponds to this signal. In addition, as the first signal, the Beacon signal in the IEEE 802.15.3 standard corresponds to this signal, and the period of that Beacon signal has been stipulated as the transmission frame period. If the communication apparatus conforms to automatic transmission output control (ATP), then the transmission output control command for maintaining the transmitted output can be used as the first signal. In the present preferred embodiment of the invention, the data length of the data section is “0” in the equipment search signal and hence only the control command is included in the signal.

In Step S105, a judgment is made as to whet her or not the terminal ID which is the response signal transmitted from the mobile telephone unit 20 with camera in response to the first signal transmitted during Step S104 was received by the wireless communication section 105 (response signal reception process). Further, the response signal is a signal that has been prescribed beforehand as the signal to be transmitted by a communication apparatus that has received the first signal, and the content of the signal is set appropriately depending on the wireless communication method. For example, the terminal ID corresponds to this in the Bluetooth method or in the method according to the IEEE 802.15.3 standard. In addition, it is possible to use the transmission output control command (ATP) if the communication apparatus conforms to automatic transmission output control (ATP).

When it is judged that the terminal ID has been received (Step S105: YES), the processing of Step 8106 is executed, and if it is judged that the terminal ID has not been received even after a specific time interval has elapsed (Step S105: NO), it is judged that either the power supply is not ON in the mobile telephone unit 20 with camera or there is no communication apparatus capable of wireless communication in the vicinity of the reception terminal 10, and the screen with the message “Processing is aborted” is displayed in the touch panel 11 of FIG. 2 (Step S113), and the processing is terminated.

In Step S106, a judgment is made as to whether the terminal ID received in Step S105 is only from one unit or not (the minimum output detection process). When it is judged that the response has been received only from one unit (Step S106: YES), the processing of Step S109 is executed, and if the responses are not from only one unit, that is, when the responses have been received from several units (Step S106: NO), the processing of Step S107 is executed.

In Step S107, a judgment is made as to whether or not the counter i has exceeded a predetermined value n. This corresponds to the number of steps by which the transmitted power output value G is reduced, and it is possible to stipulate, for example, so that the range of transmission of the signal is reduced in steps of about 30 cm. Therefore, n will be 10 if the range of signal transmission is 3 m at the transmitted power output value of Gn.

When it is judged that the counter i has exceeded n (Step S107: YES), the processing of Step S108 is executed, and if it is judged that the counter i has not exceeded n (Step S107: NO), then Step S101 is executed.

In Step S108, an input is made for selecting the terminal to carry out wireless communication (communication apparatus selection process). In other words, since several terminals are transmitting terminal IDs even at the lower limit of transmitted power output value GO that can be transmitted by the reception terminal 10 under the reduced output mode control, since it is not possible to judge with which terminal it is better to carry out wireless communication in the control section 101 of the reception terminal 10, the terminal with which to carry out wireless communication is selected by the user.

During the terminal selection input process, for example, the screen shown in FIG. 8(b) is displayed in the touch panel 11 of FIG. 2 and the user is prompted to input the terminal ID (for example, the telephone unit number) of the telephone unit 20 with camera possessed by the user, and the input of the terminal selection is completed when the user, in response to the above message, inputs the terminal ID by operating the ten keys 82 displayed in the screen.

Returning to FIG. 7 in Step S109, the encoding key is issued by the encoding key issuing section 1013 of FIG. 3 (encoding key issuing process).

In Step S110, the encoding key issued in Step S109 and the information related to the communication settings are sent as the second signal at a transmitted power output value of G to the mobile telephone unit 20 with camera (the second transmission process).

Further, the words “the information related to the communication settings” include not only the encoding key described above but also the dispersion code when the wireless communication is being done in the spread spectrum method, or the ESS-ID (Extended Service Set Identifier) specified in the IEEE 802.11 standard.

In Step S111, a judgment is made as to whether or not the confirmation signal encoded using the encoding key transmitted in Step S110 and transmitted with the communication settings sent in Step S110 is received from the mobile telephone unit 20 with camera by the wireless communication section 105. The processing of Step 112 is executed if it is judged that the confirmation signal has been received (Step S111: YES), and if it is judged that the confirmation signal has not been-received even after a specific interval of time has elapsed (Step S111: NO), the processing returns to Step S110. Further, if the confirmation signal could not be received even after the processings of Step S110 and Step S111, have been repeated a specific number of times, then, of course, the communication establishment operations are aborted.

In Step S112, after a screen with the message “Preparations for communication completed” is displayed in the touch panel 11 of FIG. 2, the processing returns to Step S20 of FIG. 6.

In Step S114, the reception by the wireless communication section 206 of the equipment search signal (the first signal) transmitted at the transmitted signal output power G in Step S104 (the first signal transmission process) is awaited. The processing of Step S115 is executed when it is judged that the equipment search signal has been received (Step S114: YES), or else, the communication establishment operations are aborted if it is judged that the equipment search signal is not received even after a specific time interval has elapsed.

In Step S115, the terminal ID is transmitted as the response signal in answer-to the equipment search signal received in Step S114.

In Step S116, the reception by the wireless communication section 206 of the encoding key and the information related to the communication settings (the second signal) transmitted at the transmitted signal output power G in Step S110 (the second signal transmission process) is awaited. The processing of Step S117 is executed when it is judged that the second signal has been received (Step S116: YES), or else, the processing returns to Step S114 if it is judged that the second signal is not received even after a specific time interval has elapsed.

In Step S117, a confirmation signal is transmitted informing that the second signal has been received in Step S116. In specific terms, a test data encoded based on the encoding key included in the second signal received in Step S116 is transmitted in the condition in which the communication settings are made based on that information related to the communication settings.

In Step S118, after a screen with the message “Preparations for communication completed” is displayed in the display section 203 of FIG. 1, the processing returns to Step S20 of FIG. 6.

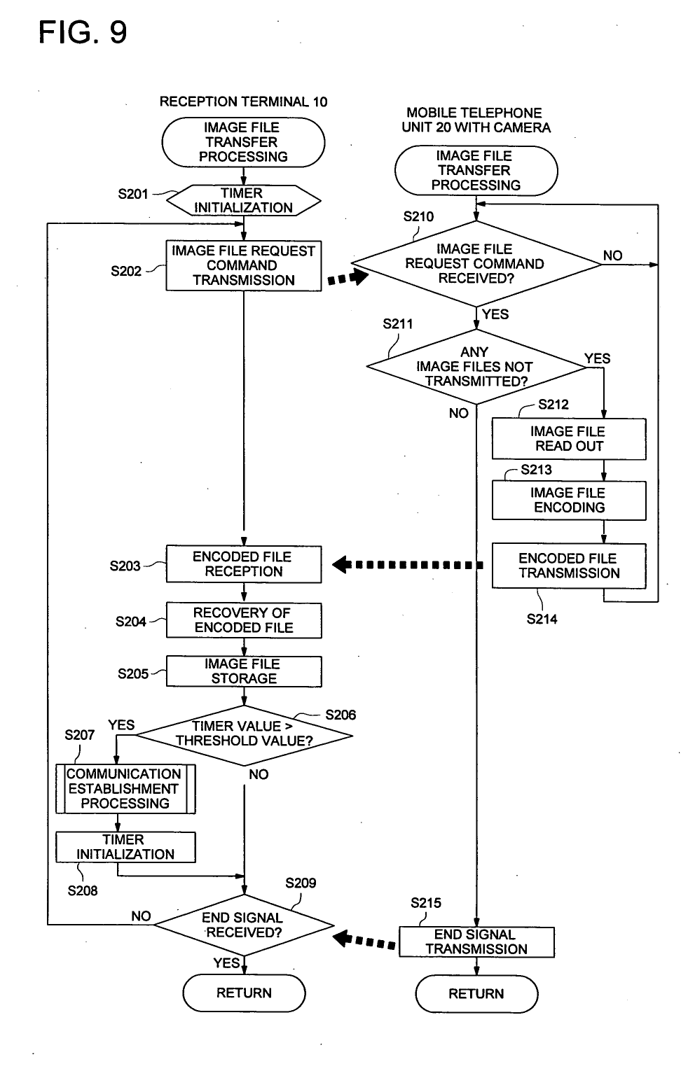

The image data transfer processing in Step S20 of FIG. 6 is explained here using FIG. 9. FIG. 9 is a flow chart showing the image data transfer processing in Step S20 of FIG. 6, wherein Steps S201 to S209 denote the processings in the reception terminal 10 from the Steps S210 to S215 denote the processings in the mobile telephone unit 20 with camera.

Further, the image data transfer processing is different from the communication establishment processing of FIG. 7, in that wireless communication is carried out in the wireless output control section 1011 in the condition in which automatic transmission output control (ATP) is carried out, and communication establishment processing is done for changing the encoded data etc., at specific intervals of time. In addition, it is desirable to carry out the transfer of image data in units of an image file.

In Step S201, the timer (clock section) not shown in the figure is initialized. Further, the timer is incorporated within the control section 101 of FIG. 1.

The image file request command is transmitted in Step S202 (image data transmission request process). The image file request command includes, for example, the terminal ID of the reception terminal 10 and the number of image files requested (1-all), etc.

In Step S203, reception is made by the wireless communication section 105 of the signal including the encoded image files that were transmitted by the mobile telephone unit 20 with camera in response to the image file request command transmitted in Step S202.

In Step S204, the signal received in Step S203 is decoded into an image file by the decoding section 1014 of FIG. 3 (decoding process).

The image files decoded in Step S204 are stored in the storage section 103 in Step S205.

In Step S206, a judgment is made as to whether or not the timer value has exceeded a predetermined value (threshold value). It is judged that the timer value has exceeded the threshold value (Step S206: YES), the processing of Step S207 is executed, and if it is judged that the timer value has not exceeded the threshold value (Step S206: NO), the processing of Step S209 is executed.

The communication establishment processing is executed in Step 207. In concrete terms, after the issuing of the encoding key, transmission of the encoding key, and the reception of the confirmation signal indicated in Steps S107 to S111 in FIG. 7 are executed, the timer value is reset (Step S208) and the processing of Step S209 is executed.

In Step S209, a judgment is made as to whether or not the end signal of the image data transfer processing transmitted by the mobile telephone unit 20 with camera is received by the wireless communication section 105. The processing returns to that of Step S30 in FIG. 6 if it is judged that the end signal has been received (Step S209: YES), and returns to the processing of Step S202 if it is judged that the end signal has not been received (Step S209: NO). Of course, it goes without saying that the image data transfer processing is aborted in case the end signal could not be received even after the processings of Step S209 and Step S202 are repeated a specific number of times.

The reception of the image file request command transmitted in Step S202 is awaited in Step S210. The processing of Step S211 is executed if it is judged that the image file-request command has been received (Step S210: YES), and the image data transfer processing is aborted if it is judged that the image file request command is not received even after a specific interval of time has elapsed.

A judgment is made in Step S211 as to whether there is any image file in the storage section 204 that has not yet been transmitted. The processing of Step S212 is executed if it is judged that there is an image file that has not yet been transmitted (Step S211: YES), and the processing of Step S215 is executed if it is judged that there is no image file that has not yet been transmitted (Step S211: NO).

The image file that is stored in the storage section 204 and that has not yet been transmitted is read out in Step S212.

In Step S213, the image file read out in Step S212 is encoded based on the encoding key received in Step S116 of FIG. 7 (data encoding process).

In Step S214, the image file encoded in Step S213 is transmitted to the reception terminal 10 and the operation returns to Step S210 (high output power communication process).

In Step S215, the processing is ended after the end signal indicating the end of the image data communication processing is transmitted to the reception terminal 10.

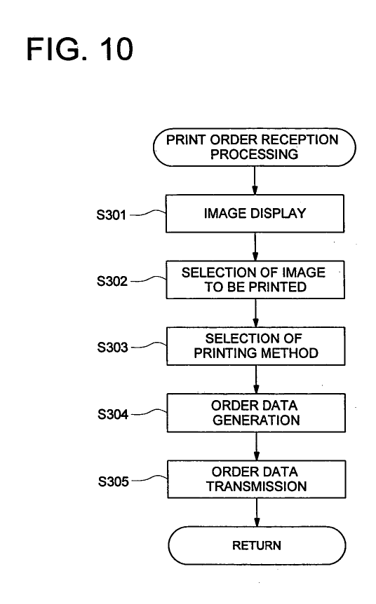

The print order reception processing in the Step S30 of FIG. 6 is described here using FIG. 10. FIG. 10 is a flow chart showing the print order reception processing in the reception terminal 10 during Step S30 in FIG. 6.

The image files stored in the storage section 104 during Step S205 of FIG. 9 are read out.

In Step S301, some specific image processing operations are made on the image files read out and then the images are displayed in the touch panel 11 of FIG. 2 based on these image files.

In Step S302, the selection of the images which are to be printed is input from the operation and display section 102 of FIG. 1 from among the images displayed in Step S301.

In Step S303, the method of printing the images selected in Step S302 is input. The method of printing implies the various settings necessary at the time of carrying out the printing based on the image files, and the printing method includes, for example, the type of printer to be used for printing the images, the size of paper to be used for printing, the number of prints, the method of receiving the prints, the method of payment of the printing charges, etc.

The print order data is generated in Step S304 based on the images selected in Step S302 and the printing method input in Step S303, and after the contents of the order are confirmed with the user. The print order data is described, for example, in the DPOF (Digital Print Order Format) format or in the XML format.

In Step S305, the print order data generated in Step. S304 and the image file are transmitted via a network N to a printer not shown in the figure. Further, considering the security, it goes without saying that the print order data and the image file transmitted via the network N would have been encoded. The processing is terminated after transmitting a message indicating that the print order has been accepted to the mobile telephone unit 20 with camera via the mobile communication network M.

Further, in the present preferred embodiment, although the explanations were given taking the example of a print order reception terminal as the first communication apparatus, these descriptions apply equally well to a printer having wireless communication functions. In this case, the reception terminal 10 in FIG. 1 is one that has an image forming section that forms images on recording material based on the image data, and has a step (image forming step) of carrying out image formation based on the image files stored in the storage section 103 in Step S205 of FIG. 9.

In addition, it goes without saying that the purpose can also be achieved by providing a recording medium in which are recorded the software programs realizing the functions of the preferred embodiment described above to a system or an apparatus, and by having a computer (CPU or MPU) read out and execute the programs stored in the recording medium.

Apart from this, even regarding the detailed configurations of the different constituent elements configuring the communication apparatus and the detailed operations, it is possible to make appropriate modifications without deviating from the purpose and scope of the invention.

According to the embodiments, after transmitting the first signal from the first communication apparatus to the second communication apparatus while reducing the output, by detecting the lowest limit of transmission output at which reception is possible by the second communication apparatus based on the transmitted power output of the first signal and on the response signal returned in response to the first signal, and by transmitting the second signal from the first communication apparatus to the second communication apparatus at a transmission power output equal to said detected power output, it is possible to carry out wireless communication in a stable manner of authentication information and settings information with the second signal not reaching any communication apparatus other than the second communication apparatus and without being affected by the orientation of the communication apparatuses, weather, and the installation environment, etc.

For example, when a plurality of users simultaneously use a plurality of print order reception terminals that are compatible with wireless communication and that are installed in a shop, since, after establishing the communication by first transmitting to a photographing apparatus such as a mobile telephone with camera possessed by a user using a print order reception terminal the predetermined communication settings information such as the encoding key or ESS—ID unique for the print order reception terminal, the wireless communication is started by encoding based on said communication settings information, it is possible for other users to view and print image data, even if the wireless electromagnetic waves transmitting the image data reach the print order reception terminals being operated by other users.

Further, since the data is encoded with the communication settings based on the communication settings data and the encoding key included in the second signal transmitted at the minimum limit of transmission output power, and also since high power output wireless communication is made, it is possible to transmit a large volume of data at a relatively stable transfer speed while maintaining the security.

In addition, since the equipment search signal for detecting the equipment that can become the target for wireless communication is transmitted while reducing the output power, and since the minimum limit of the transmission output power is detected based on the transmitted power output of the equipment search signal and on the response signal in answer to that equipment search signal, and since the encoding key issued for that wireless communication is transmitted at the detected transmission output power, and since the communication is carried out by encoding the data based on the transmitted encoding key, it is possible to carry out wireless communication in a stable manner of authentication information and settings information without being affected by the orientation of the communication apparatuses, weather, and the installation environment, etc., and it is possible to transmit a large volume of data at a relatively stable transfer speed while maintaining the security.

1. A communication method of using wireless communication between a first communication apparatus and a second communication apparatus, comprising steps of;
transmitting a first signal while decreasing output of the first signal from the first communication apparatus to the second communication apparatus,
receiving a response signal from the second communication apparatus in answer to the first signal transmitted by the first signal transmission step,
detecting a minimum output, which is the lower limit of the transmitted power output that can be received by the second communication apparatus based on the transmitted power output of the first signal transmitted in the first signal transmission step and the response signal received in the response signal receiving step, and
transmitting a second signal from the first communication apparatus to the second communication apparatus with the transmitted power output based on the power output detected in the minimum output detection step.

2. The communication method of claim 1, wherein the second signal includes information related to the communication settings of the second communication apparatus, and further comprising steps of:
setting a communication setting of the second communication apparatus based on the second signal transmitted by the second signal transmission step, and
performing the wireless communication of high output during the first communication apparatus and the second communication apparatus using the communication settings set by the communication setting step.

3. The communication method of claim 1, wherein the second signal includes an encoding key for encoding data, and further comprising step of:
encoding the data based on the second signal transmitted by the second signal transmission step, and
performing the high output communication during the first communication apparatus and the second communication apparatus using data encoded by the data encoding step.

4. The communication method of using wireless communication between a first communication apparatus and a second communication apparatus, comprising steps of:
transmitting an equipment search signal while decreasing the output of the equipment search signal from the first communication apparatus to the second communication apparatus, wherein the equipment search signal includes a signal to detect an equipment of the target of connection of wireless communication,
receiving the response signal from the second communication apparatus in answer to the equipment search signal transmitted by the equipment search signal transmission step,
detecting a minimum output, which is the lower limit of transmitted power output that can be received by the second communication apparatus based on the transmitted power output of the equipment search signal transmitted in the equipment search signal transmission step and the response signal received in the response signal receiving step,
issuing the encoding key for encoding the data,
transmitting the encoding key issued by the encoding key issuing step from the first communication apparatus to the second communication apparatus with the transmitted power output based on the power output-detected in the minimum output detection step,
encoding data based on the encoding key transmitted by the response signal transmission step,
transmitting the data encoded by the data encoding step from the first communication apparatus to the second communication apparatus, and
decoding the data transmitted by the data encoded signal transmission step based on the encoding key issue by the data encoding key issuing step.

5. A communication apparatus of using wireless communication between the communication apparatus and other communication apparatus:
a wireless communication section,
a wireless output control section to control the transmitted power output of the wireless communication section, a minimum output detection section to detect the lower limit of transmitted power output that can be received by other communication apparatuses,
wherein the wireless output control section to control the wireless communication section transmit the first signal to the other communication apparatus while reducing the transmitted power output, and to transmit the second signal to the other communication apparatus at a transmitted power output based on the transmitted power output detected by the minimum output detection section,
wherein the wireless communication section receives the response signal from the other communication apparatus sent in answer to the first signal transmitted previously, and the minimum output detection section detects the minimum transmitted power output that can be received by the other communication apparatus based on the transmitted power output of the first signal transmitted by the wireless communication apparatus, and the response signal received by the wireless communication apparatus from the other communication apparatus sent in answer to the first signal.

6. The communication apparatus of claim 5, wherein the second signal includes information related to the communication settings of the other communication apparatus, and the wireless communication section to perform high output wireless communication with the other communication apparatus using the communication settings included in the second signal.

7. The communication apparatus of claim 5, wherein the second signal including an encoding key for encoding the data, and the wireless communication section receives the data encoded by the encoding key included in the second signal.

8. A communication apparatus of using wireless communication between the communication apparatus and other communication apparatus, comprising:
a wireless communication section,
a wireless output control section to control the transmitted power output of the wireless communication section,
a minimum output detection section to detect the lower limit of the transmitted power output that can be received by other communication apparatuses,
a data encoding key issuing section to issues the encoding key for encoding the data, and
a data decoding section to decode the data based on the encoding key issued by the data encoding key issuing section,
wherein the wireless output control section to control the wireless communication section transmit the equipment search signal for detecting an equipment that becomes the target of connection of wireless communication targeting other communication apparatuses while reducing the transmitted power output, and to transmit the encoding key issued by the data encoding key issuing section targeting the other communication apparatus at a transmitted power output based on the transmitted power output detected by the minimum output detection section,
wherein the wireless communication section receives the response signal from the other communication apparatus sent in answer to the equipment search signal transmitted previously,
wherein the minimum output detection section detects the minimum transmitted power output that can be received by the other communication apparatus based on the transmitted power output of the equipment search signal transmitted by the wireless communication apparatus and based on the response signal received by the wireless communication apparatus from the other communication apparatus sent in answer to the equipment search signal,
wherein the wireless communication section receives the encoded data, and the decoding section decodes the data received using the wireless communication section.
